(19) United States
(12) Patent Application Publication
(10) Pub. No.: US 2016/0072863 A1
(43) Pub. Date: Mar. 10, 2016

(54) Desktop Control in Online Conferencing

(71) Applicant: Cisco Technology, Inc., San Jose, CA (US)

(72) Inventors: Yuan Wu, Suzhou (CN); Haihua Huang, Suzhou (CN); Qian Wang, Suzhou (CN)

(21) Appl. No.: 14/481,527

(22) Filed: Sep. 9, 2014

(51) Int. Cl. H04L 29/06; H04L 29/08; G06F 3/0484

(52) U.S. Cl. CPC H04L 65/4046; G06F 3/04842; H04L 67/10

(57) ABSTRACT

In one embodiment, a method includes presenting content from a screen of a presenter in an online conference on screens of a plurality of attendees; identifying a primary speaker in the online conference, the primary speaker being a first one of the attendees and other than the presenter; and showing, to the presenter and the attendees, interaction of user input of the first attendee with the content only where the first attendee is the primary speaker.

### TECHNICAL FIELD

This disclosure relates in general to the field of computer networks and, more particularly, to online conferencing with improved user experience.

### BACKGROUND

In real-time online conferencing, a presenter may move their mouse or otherwise manipulate content being shared with participants. Attendees see the cursor on the shared content. This allows attendees to quickly understand the context of the presenter's discussion. However, if an attendee wants to quickly point out information in the shared content during the presentation, there is no convenient way to manipulate the content or control the cursor. As a result, the location relative to the content is explained verbally, costing time. Alternatively, the presenter gives the attendee annotation permission, which also takes time to arrange through a request and authorization exchange. Once having annotation, the position of the attendee cursor may not be displayed on the shared content to others. Instead, the attendee must actually annotate, such as select and enter, on the shared content before the other attendees and presenter see selection of the attendee. Annotation is a good feature for group discussion, but may not be suitable for a quick indicator on shared content.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a simplified block diagram of an example network for desktop control in online conferencing;

FIG. 2 is a flow chart diagram of one embodiment of methods for desktop control in online conferencing;

FIG. 3 is a diagram of an example method for desktop control in online conferencing;

FIG. 4 represents an example screen in online conferencing; and

FIG. 5 is a block diagram of an online conferencing device, according to one embodiment, for desktop control in online conferencing.

### DESCRIPTION OF EXAMPLE EMBODIMENTS

### Overview

By identifying a primary speaker or through other voice activation, the speaking or primary attendee may share their cursor position or other manipulation of shared content without any request and/or authorization exchange. Different or additional verifications may be used to allow showing of cursor position or manipulation of shared content by an attendee, such as checking that the shared content window is on a foreground or active and that the cursor or other input is within the window.

In one aspect, a method includes: presenting content from a screen of a presenter in an online conference on screens of a plurality of attendees; identifying a primary speaker in the online conference, the primary speaker being a first one of the attendees and other than the presenter; and showing, to the presenter and the attendees, interaction of user input of the first attendee with the content only where the first attendee is the primary speaker.

In another aspect, logic is encoded in one or more non-transitory computer-readable media that includes code for execution. When executed by a processor, the logic is operable to perform operations, including: displaying at least a part of a computer desktop from a presenter of an online conference on a screen; receiving user input moving a cursor on the screen; verifying that the part of the computer desktop from the presenter is on a foreground of the screen; verifying that the cursor is within the part of the computer desktop from the presenter; and transmitting, to a conferencing server, a position of the cursor or action associated with the cursor when both verifications are positive.

In yet another aspect, an arrangement includes: an interface configured to receive position information from a top attendee, the position information being relative to shared content of an online conference; and a processor configured to determine the top attendee in the online conference, the online conference including a presenter and multiple attendees, to update the shared content according to interaction using the position information from the top attendee, and to prevent alteration of the shared content by the attendees other than the top attendee; wherein the interface is configured to transmit the shared content as updated.

### Example Embodiments

An attendee may want to quickly point to the sharing area in order to indicate content being discussed. Relying on verbal description of the location of content or negotiating annotation costs time and delays the meeting. To more quickly point to shared content, a temporary indicator is provided on the shared content based on input from a top or active speaker. The speaking attendee may quickly indicate or otherwise interact with shared content. The user experience, especially for mobile users, may benefit from greater online meeting efficiency.

To avoid many interacting at a same time and/or accidental interaction, one or more conditions may be established to allow the attendee to interact with the shared content. Rather than requiring manual permissions, the conditions are automatically determined by the attendee's computer, the presenter's computer, and/or the video conferencing server. Example conditions may include requiring the attendee to be the top speaker, have the shared content on the foreground of their computer, and have the input location be on the shared content rather than elsewhere on the desktop or computer screen. Movement of the input location may be required, such as a change in cursor position.

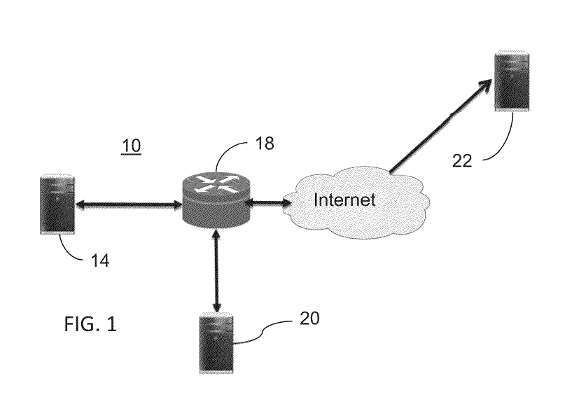

FIG. 1 shows an example network 10 for online conferencing. A media session between end-point devices 14, 20 and 22 or peers is created. Any number of end-point devices 14, 20, and 22 may be used, such as just two. The online conference is hosted by the network 10 for providing audio, video, and/or synthetic content between the end-point devices 14, 20, and 22. For video conferencing, the online conferencing server 18 may combine decoded inputs from different end-point devices 14 and 20 for encoding a combined video stream. For video or other online conferencing, the online conferencing server 18 may provide shared content from a presenter combined with an interaction from an attendee. In one embodiment, the network 10 supports operation of a telepresence or WebEx system from Cisco, but other online conferencing may be provided.

Additional, different, or fewer components may be provided in the network 10. For example, additional or fewer end-point devices to participate in a given media session, additional third-party servers, or different networks are provided. As another example, the online conferencing server 18 is not provided, with an end-point device 14, 20, 22 instead hosting the video conference. In other examples, the network 10 may be many different devices connected in a local area network, wide area network, intranet, virtual local area network, the Internet, or combinations of networks. Any form of network may be provided, such as transport networks, data center, or other wired or wireless network. The network 10 may be applicable across platforms, extensible, and/or adaptive to specific platform and/or technology requirements.

The network devices (e.g., end-point devices 14 and 20) of the network 10 are in a same room, building, facility or campus, such as part of a same enterprise network. In other embodiments, the network 10 is formed with devices distributed throughout a region, such as in multiple states and/or countries. The end-point devices 14, 20, 22 may be in different networks.

The network devices are connected over links through ports. Any number of ports and links may be used. The ports and links may use the same or different media for communications. Wireless, wired, Ethernet, digital subscriber lines (DSL), telephone lines, T1 lines, T3 lines, satellite, fiber optics, cable, cellular, and/or other links may be used. Corresponding interfaces are provided as the ports.

The online conferencing server 18 is a server for managing or controlling the conference. The online conferencing server 18 receives any inputs, such as audio, video, and/or user inputs, from the various end-point devices 14, 20, 22, determines information to output as part of the conference from the inputs, and transmits shared content, audio, and/or video to the end-point devices 14, 20, 22. In one embodiment, the online conferencing server 18 is a decoder and an encoder for receiving encoded inputs from the end-point devices 14 and 20, decoding the inputs, assembling video (e.g., combining input videos) and encoding the assembled video for output to any or all of the end-point devices 14, 20, and/or 22. The online conferencing server 18 is an application specific integrated circuit, a computer, a conference server, or other hardware. Any now known or later developed conferencing server or host may be used.

Any number of end-point devices 14, 20, 22 may be provided. The end-point devices 14, 20, 22 are computers, conference servers, tablets, cellular phones, Wi-Fi capable devices, laptops, mainframes, voice-over-Internet phones, or other user devices participating in a media session. The end-point devices 14, 20, 22 connect with wires, such as Ethernet cables, or wirelessly, such as with Wi-Fi. The connection may be relatively fixed, such as for personal computers connected by wires to switches. The connection may be temporary, such as associated with mobile devices. The end-point devices 14, 20, 22 may include encoders and/or decoders.

The end-point devices 14, 20, 22 may include one or more user input devices. For example, a mouse and keyboard are provided. As another example, a touch screen is provided. The end-point devices 14, 20, 22 include a microphone or speaker that may act as a microphone. One or more of the end-point devices 14, 20, 22 may include a camera. A microphone and speaker allow for audio communications as part of the video or online conference. A camera and display allow for video of the presenter and/or attendees as part of the video or online conference. Video may not be provided in other embodiments. The displays of the end-point devices 14, 20, 22 allow for display of shared content, such as display of the desktop or conference window of a presenter. For example, a document or application is displayed as shared content on the displays of the end-point devices 20 and 22 where the shared content is hosted or originates from the end-point device 14.

A processor, computer, server, memory, or other device creates and/or captures synthetic data at one or more end-point devices 14, 20, 22. For example, a personal computer or conference server generates a POWER POINT or other presentation using software or a program. The synthetic content may be captured in real-time. Alternatively, the synthetic content is captured only upon a trigger, such as a change in the display.

At any given time, one or more of the end-point devices 14, 20, 22 are capturing audio and/or video. Any given end-point device 14, 20, 22 may be capturing audio, outputting audio, or both at a given time. The operation may change over time, such as one end-point device 14 capturing audio while the local attendee is speaking and then outputting audio while a user local to a different end-point device 20 is speaking. Similarly, the input source at a given end-point device 14, 20, 22 may change, such as switching between camera capture and receipt of synthetic data as shared content. Any conferencing arrangement or operation may be provided.

The end-point devices 14, 20, 22 are configured to initiate or participate in a media session. The end-point devices 14, 20, 22 operate pursuant to a real-time protocol (RTP) or other communications protocol for video and/or audio communications with data sharing. As part of the media session, content from another source may be added or incorporated. For example, data from one or more authorized sources, such as a financial services server, search engine, drop box database, or other source, is to be included in the media session. The web content is requested pursuant to TCP/IP or other protocol. The presenter controls the shared content.

The various components of the network 10 are configured by hardware and/or software to operate for video or online conferencing. Logic is provided in one or more non-transitory computer-readable media for operating the end-point device 14, end-point device 20, end-point device 22, and/or conferencing server 18. The media is a memory. Memories within or outside the network 10 may be used. The logic includes code for execution by a processor or processors, such as processors of the end-point devices 14, 20, 22 or conferencing server 18. When executed by a processor, the code is used to perform operations for allowing and presenting attendee interaction with shared content.

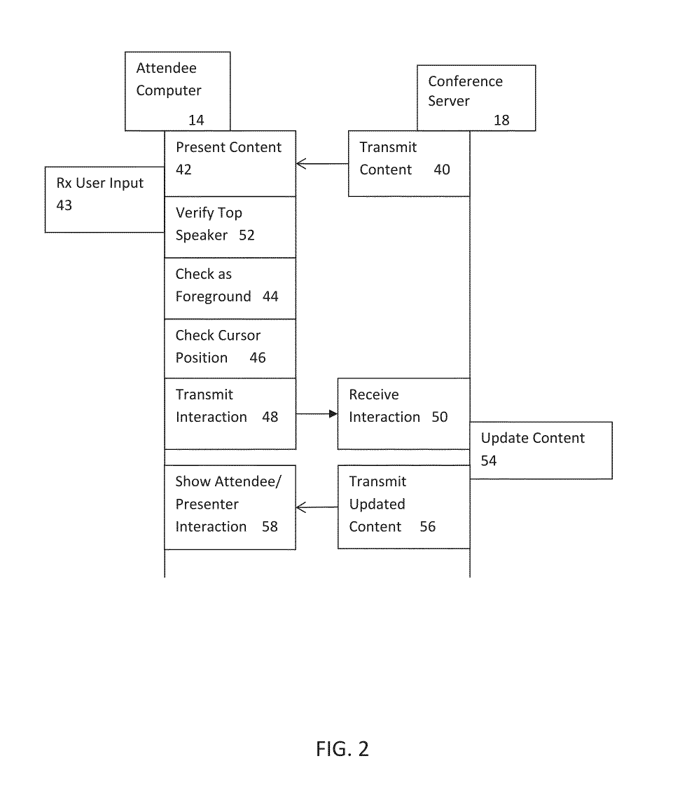

FIG. 2 shows a method for desktop control in online conferencing. The online conferencing includes display of shared content. Video of the presenter and/or attendee may or may not be provided. In one embodiment, the online conference is a WebEx conference. In another embodiment, the online conference is a telepresence conference. Other online conferencing applications or programs may be used.

In the example of FIG. 2, one attendee computer and the conference server 18 are shown. This arrangement is used to represent interaction by an attendee with shared content. The shared content may be from a presenter, but is provided to the attendees, including the one shown as attendee computer 14, by the conference server 18. In alternative embodiments, an end-point device, such as for a presenter, performs the acts of the conference server 18. Other attendee computers may be included as well for receiving and presenting content. If the attendee being allowed interaction with the shared content changes, then a different attendee computer performs the actions of the attendee computer 14 in FIG. 2.

Various acts 40-58 are shown in FIG. 2. Additional, different, or fewer acts may be performed. For example, acts 44 and/or 46 are not performed, such as where the method provides attendee interaction based only on the attendee being the primary speaker. As another example, act 52 is not performed where one or both of acts 44 and 46 are used instead. In yet another example, messaging and/or other acts for online conferencing are performed in addition to the acts shown, such as acts for the presenter to provide the shared content in the first place and acts for determining which audio to transmit to the attendees and presenter.

The acts are performed in the order shown, as represented vertically with the first acts occurring at the top of FIG. 2 and as represented by the arrows. In other embodiments, other orders are provided, such as performing the check of act 44 before receiving the user input in act 43. Acts 52, 44, and 46 may be performed in any order. FIG. 2 represents the order of acts for a particular attendee interaction, but an on-going interaction with shared content by the same attendee or a different attendee is provided by repetition of the acts.

The acts are performed by the attendee computer 14 and the conference server 18, such as acts 40, 50, 54, and 56 being performed by the conference server 18 and acts 42, 43, 52, 44, 46, 48, and 58 being performed by the attendee computer 14 (end-point device). Similarly, acts 42 and 58 are also performed by other attendee computers at a same time. In other embodiments, connected or local components, such as a server, processor, or different computer performs one or more of the acts. Similarly, the distribution of acts between the attendee computer 14 and the conference server 18 may be different. For example, the conference server 18 provides the checks of acts 52, 44 and/or 46 based on information provided by the attendee computer 14.

In act 40, shared content is transmitted from the conference server 40. The shared content is a document, presentation, application, or other information. For example, the shared content is a POWER POINT presentation, a table of a spreadsheet, a document, a .pdf, a web site, a picture, a video, and/or an application. The shared content may be from a local memory or downloaded from a remote source. In one embodiment, the shared content is a single window of information or multiple windows of information, such as any windows or delineated data in an online conference window. In another embodiment, the shared content is an entire desktop.

The shared content is from a presenter. The presenter selects the shared content and the online conferencing application provides the shared content to the conference server 18 for distribution to attendees. In other embodiments, one of the attendees provides the shared content, such as through permission or prior arrangement by the presenter and/or presenter's computer. Regardless of the source, the conference server 18 (or source computer) transmits the shared content to other attendees.

In act 42, the attendee computer 14 presents the shared content on a screen. The shared content on the presenter's screen is also presented on the screen of the attendee computer 14 and the screens of any other attendees. The desktop, application, or other shared content is shared with the attendees and presenter for the online conference. For example, the presentation of the shared content from the computer of the presenter on the screen of the attendee allows both the presenter and the attendee to view the same content.

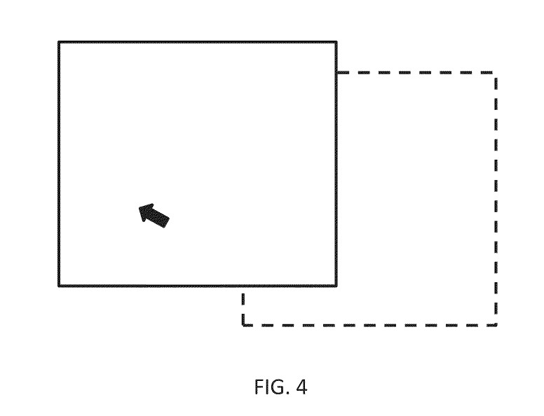

The shared content is displayed to the attendee. On the screen of the attendee's computer 14, only the shared content or the shared content and other information is displayed. For example, FIG. 4 shows two windows on a display of a personal computer of an attendee. The dashed window represents an inactive window in the background with content not being shared, such as a document, email, folder, web browser, or other program. The solid window represents the location of display of the shared content. Where the shared content is the entire desktop of the presenter or an attendee, this shared content may be in the window covering part of the desktop as presented at the attendee computer 14, but may be maximized to cover all or most of the screen. Other presentations than in windows may be used, such as through tabs on a browser.

During the display, the presenter or another attendee may be discussing some aspect of the shared content. The presenter may highlight, point to, manipulate, or otherwise interact with the shared content. This interaction is shown to the attendees in the attendee display. The audio is similarly provided to and output by the attendee computer 14.

In act 43, user input is received by the attendee computer 14. The attendee operates one or more user input devices. The operation is sensed or communicated to the processor of the attendee computer 14.

Any operation of any user input device may be received. For example, the user moving a cursor on the screen of the attendee computer results in receipt. The user touches a touchscreen at a location or drags their finger or stylus on the screen to move the cursor. As another example, the user uses a mouse, touchpad, and/or trackball to move the cursor. The cursor is represented by an arrow, pointer, or other graphic on the attendee computer 14. Other operations include clicking or selection, dragging, zooming, minimizing, maximizing, re-sizing, highlighting, or other user inputs interacting with the content of the screen.

The attendee may be operating the user input for purposes other than attempting to point out shared content to other participants in the online conference. Acts 44 and 46 are directed to distinguishing between operation of the user input for the online conference from operation for other purposes (e.g., email, gaming, drafting, or other uses of the computer). Similarly, to avoid confusion, act 52 is performed so that a limited number (e.g., one) speaker may cause interaction with the shared content.

In act 52, the attendee computer 14 checks that attendee for that computer is the top speaker of the online conference. The top attendee or speaker is the attendee with the most recent, greatest audio energy. The top attendee is the primary speaker. For example, the online conferencing application run by the conference server 18 determines which audio to pass to the participants. Rather than pass all audio, only the audio of the loudest speaker is passed. The loudest may be a measure at a given time or a measure over a period of time (e.g., average, peak, or integral over 5 seconds). The same criterion or criteria are used to verify that the interaction with shared content is from the top attendee of the online conference. Other criteria may include ranking on an organization chart, confidence that audio energy is not from background, indication of push to talk as opposed to voice activation, or any other consideration. In other embodiments, different standards are used for passing audio than for allowing interaction with the shared content.

The primary speaker is identified. In the audio example, the conference server 18 may have a list of speakers, with one assigned as the primary or top. In one embodiment, the conference server 18 provides an audio list including the top five or other number of speakers (e.g., conference server compares all unmuted attendee's voice inputs in real-time to identify the five with the greatest audio energy). This list is provided by the conference server 18 to the attendee computers 14 whenever the list changes, such as when the order of the list changes and/or different attendees are removed and added to the list. In alternative embodiments, acts 48 and 50 occur prior to act 52, and the conference serer 18 performs act 52.

The primary or top attendee may change over time. The identification of the top attendee may persist. For example, someone speaks within a period and no one else does. That person is assigned as the top attendee. If silence follows, that person is still the top attendee. If someone speaks more loudly or speaks after a threshold amount of time of silence, then the other person may become the top speaker. If more than one attendee is the top speaker (e.g., same audio energy at a same time), then no one is the top speaker and interaction is not triggered. Alternatively, both or a most recent top speaker are allowed interaction.

The top speaker may be the presenter or one of the attendees. In other embodiments, only an attendee may be a top speaker, and the presenter always receives interaction and/or audio sharing. Only one top speaker may trigger interaction being shown on shared content. In alternative embodiments, the verification of act 52 is that the attendee associated with the interaction is one of the top two, three, or other number of speakers. For example, a list of the top five attendees by user identification is maintained once the audio portion starts. Any member of the top five or subset of the top five may qualify for passing on interaction to other participants.

The identification of the primary speaking attendee for the verification in act 52 may account for background noise. For example, a filter is applied to filter out background audio. The loudness is calculated after filtering to remove noise. Alternatively, no filtering is provided. The calculation of energy may not consider noise or may be for frequencies associated with speaking and less associated with noise.

In act 44, the attendee computer 14 checks that the shared content of the online conference is on a foreground of the screen of the attendee. By verifying that the shared content from the presenter or other source is on the foreground, an indication is provided that the attendee intends to interact with the shared content. Additionally or alternatively, the verification is that the shared content is active, such as being in a currently selected window. If on the foreground, the window or shared content may most likely be active, but a separate check for active status may be used where the operating system allows for interaction with the operating system without any window being active.

FIG. 4 shows an example. The solid line window is shown as on the foreground. The dashed line window is in the background. The background window may be minimized instead. The solid line window may be active but minimized in some embodiments. If the shared content is in the solid line window, then this is an indication that the user intends to interact with the shared content. If in the dashed line window or other location on the screen, then this is an indication that the user intends to interact with a different application than the online conference.

The verification may include a temporal component. For example, the user input over multiple seconds is used. If at the end of the time period, the shared content is on the foreground and/or active, then the check is satisfied (e.g., the user intends to interact with the shared content). By providing a time period, the user has the opportunity to activate and/or place on the foreground the window for the online conference (with the shared content).

The check is performed in response to any user input. Alternatively, the check for the user input is performed only if the online conference is active and/or on the foreground. The combination of both user input and foreground and/or active provides for moving to the check of act 46. The attendee computer 14 performs the check of act 44 when active and/or on the foreground, so the check is performed by the user input being received while the shared content is on the foreground or active.

In act 46, the attendee computer 14 checks that the user input, such as the cursor location representing a location of user interaction relative to content on the screen, is within the shared content. For example, the cursor as a graphic or an indication of user location of focus (e.g., place of tapping) is verified to be within the part of the computer desktop of the attendee computer dedicated to shared content.

If the cursor for interacting with the displayed content is positioned on or positioned to be within the shared content, then an indication is provided that the attendee intends to interact with the shared content. If the cursor is outside of the shared content, then the intent may be to interact with a different application than the online conference and/or with different content.

The check may be over a period so that the end position of a moving cursor or focus of interest is verified as being in the shared content. The check may additionally or alternatively include a check that the cursor is moved rather than static.

Additional, different, or fewer checks may be provided. For example, the user may be required to select a button or click in a certain way or at a location to indicate the intent to interact with shared content. As another example, a check may verify that the user intends to interact with the shared content as opposed to optional controls of the online conference itself using position and/or actions of the user input relative to the window of the shared content and/or online conference window housing the shared content.

If the attendee computer 14 determines that the attendee intends to interact with the shared content, the interaction is transmitted to the conference server 18 by the attendee computer 14 in act 48. Any transmission may be used, such as a transmission following a protocol used for online conferencing communications.

The interaction is transmitted as a cursor location, a selection and what is selected, and/or as an indication of the type, effect, or other characteristic of any interaction with the shared data. In one example embodiment, the interaction is transmitted as a Cartesian coordinate location relative to the shared content.

In act 50, the conference server 18 receives the interaction. The interaction information may be used to update content in act 54 for displaying the interaction to other participants. In one embodiment, one or more further checks are performed before propagating the attendee interaction to other participants on the online conference.

In act 54, the shared content is updated. The interaction received in act 50 that passes the check of act 44, check of act 46, and/or the verification of act 52, is used to update the shared content. For example in FIG. 4, the arrow or pointer corresponding to the cursor or selection of the interaction is added to the shared content. The attendee's on-going interaction is added. The shared content may be further altered by the interaction, such as through moving, zooming or other interaction.

In one example, an attendee has questions about shared content at the location of the cursor in FIG. 4. This attendee interrupts the presenter by asking: “How is that related?” At this moment, the attendee is the top speaker, has the shared content active and in the foreground on their computer, and the cursor is positioned within the shared content. Because of this, the conference server automatically updates the shared content to show the pointer of FIG. 4 with the shared content. If the attendee moves the cursor or performs other interaction, that interaction may or may not also be used to update the shared content.

The update may include additional information. For example, the updated information is color coded or tagged with an indication of the attendee making the update. For example, a name and/or picture for the attendee is provided as part of the update (e.g., on or by the added pointer). Alternatively, the update is displayed without an indication of the source of the interaction.

The update is by adding an overlay. Alternatively, the shared content itself is updated, such as by allowing replacement of text. The update lasts until actively changed back. In another embodiment, the update persists for a limited time. For example, once one or more of the checks is no longer satisfied, the update (e.g., pointer) is removed or lasts for a limited amount of time (e.g., 5 seconds). The persistence of the update may be timed from when the update occurs, such as lasting 5 seconds even if all of the checks and/or verifications are satisfied. Similarly, the update may vary over time. For example, the attendee moves the cursor. Rather than leaving a trail of pointers, the original pointer is replaced with a pointer at the current location of the cursor. Limited timing is then applied once the interaction becomes static.

In act 56, the updated shared content is transmitted to the attendee computer 14 by the conference server 18. The shared content is transmitted anytime there is a change. Alternatively, the shared content is transmitted periodically or in response to a request. In alternative embodiments, the update itself is transmitted for the attendee computer 14 to add to or remove from the shared content. The computers of the participants update the shared content with the updated propagated by the conference server 18.

The updated shared content is transmitted to all of the participants (i.e., attendees and presenter). The conference server 18 provides the updated shared content to the presenter and the attendees, including the attendee interacting with the shared content. Alternatively, the updated is provided to a sub-set of the participants, such as just the presenter or such as to all participants except for the attendee making the changes. The presenter, other person, or defaults may be used to restrict who is provided with the updated shared content.

In act 58, the computers of the participants, including the attendee computer 14, show the interaction of the user input of act 43 with the shared content. The presenter and/or other attendees are shown the pointer or other interaction with the shared content. The updated shared content is displayed. As the attendee questions the presenter, the pointing or interaction of the attendee to direct attention on the shared content is provided to the presenter and/or other attendees. For example, the pointer is labeled with the identity of the attendee interacting with the content and moves as that attendee moves their cursor. As another example, any zooming, moving, selecting, replacing, annotation, or other interaction performed by the attendee is reflected in the displayed, updated shared content.

The display of the interaction occurs only when one, some, or all of the checks and verifications of acts 44, 46, and 52 occur. For example, the interaction is provided and displayed only when the attendee providing the interaction is the primary speaker, has the shared content or online conference in the foreground and active on their screen, and positions their interaction (e.g., cursor) within or over a portion of the shared content. Otherwise, the interaction is not shown to other participants (e.g., not shown to the presenter).

The interaction is shown or continues to be shown until one or more of the checks of acts 44, 46, and 52 are no longer true. For example, the attendee computer 14 continues to show the interaction or pointer on the shared content until another speaker is assigned as the primary speaker, until the attendee providing the interaction moves the shared content or online conference window to the background, or until the attendee providing the interaction moves the cursor or interaction away from the shared content. The interaction may continue to be shown even while the primary speaker is not speaking. As long as another participant is not assigned to be or identified as the primary speaker, the interaction of the attendee continues.

Alternatively or additionally, the interaction continues for a limited time. The interaction or change persists for five seconds or other time after ceasing or from a beginning. Once the time period is over or the interaction of a given attendee is not longer to be shown, the interaction is removed. For example, the pointer is removed and the shared content returns to reflect the content provided by the presenter. Zooming, selection, annotation, or other interaction may be undone. Unlike a paint brush or other alteration of annotation, the interaction only shows the temporary location of interest to the attendee and does not leave any traces. Settings may be used to control the length of persistence and/or what types of interactions are removed and what types may remain.

The interaction of more than one participant and corresponding changed shared content may be displayed at a same time. For example, an additional interaction of the presenter is used to change the shared content and is displayed with the interaction of the attendee. Both interactions are shown together. Where more than one attendee may interact, the interactions of three or more participants may be shown at a same time. Alternatively, only the interactions of the presenter and one attendee or only the interaction of one attendee are displayed. Where the interactions of multiple participants conflict, a priority may be used for selecting the interaction to show. For example, the presenter's interaction takes priority over any attendee's interaction. The attendee interaction may be limited to times in which the presenter is not interacting with the shared content. As another example, the interaction of a primary or top speaker takes priority over the interaction of another attendee that is not the top speaker.

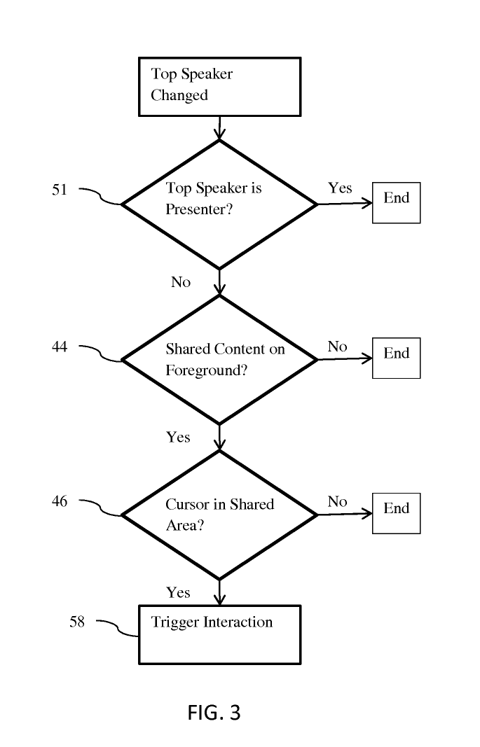

FIG. 3 shows one embodiment of a method for desktop control in online conferencing. In this example, the top speaker is changed. As that change occurs, the method to check for desktop interaction by the new top speaker with the shared content is performed. Act 51 is performed to determine whether the top speaker is the presenter. If the top speaker is an attendee, interaction of an attendee with the shared content may occur. If an attendee, then the shared content for the attendee is checked for whether activation and positioning by the operating system of shared content in the foreground in act 44. If the shared content is in the foreground and active, the location of the cursor to or in the shared content area is determined in act 46. If true, then the display of the interaction to the presenter and/or other participants is performed in act 58.

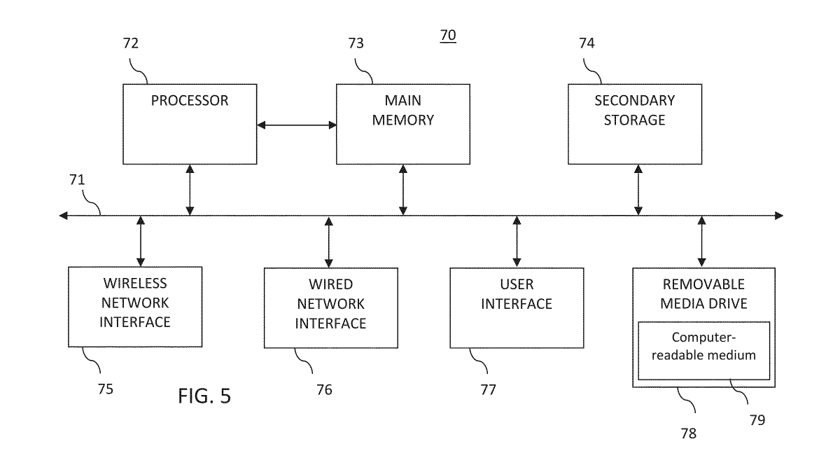

FIG. 5 is one embodiment of an apparatus for desktop control in online conferencing. The apparatus is shown as a simplified block diagram of an example network device, such as the end-point device 14, 20, 22, or conference server 18 of FIG. 1. In FIG. 5, the example network apparatus or device 70 corresponds to network elements or computing devices that may be deployed in the conferencing network 10. The network device 70 includes software and/or hardware to perform any one or more of the activities or operations for checking, verifying, updating, transmitting, receiving, and/or displaying for interaction by an attendee with shared content.

The network device 70 includes a processor 72, a main memory 73, secondary storage 74, a wireless network interface 75, a wired network interface 76, a user interface 77, and a removable media drive 78 including a computer-readable medium 79. A bus 71, such as a system bus and a memory bus, may provide electronic communication between processor 72 and the other components, memory, drives, and interfaces of network device 70.

Additional, different, or fewer components may be provided. The components are intended for illustrative purposes and are not meant to imply architectural limitations of network devices. For example, the network device 70 may include another processor and/or not include the secondary storage 74 or removable media drive 78. As another example, the network device 70 connects with a camera and/or microphone. Each network device may include more or less components than other network devices.

The network device 70 is personal computer, tablet, smart phone, server, network processor, or other computer. In one embodiment, the network device 70 is a conferencing server or user computer (e.g., personal computer, laptop, smart phone, tablet, or mobile device) with conferencing capability or software. The network device 70 may be a computer with web browsing software where the web browser displays the conferencing information from a server.

In one embodiment, the network device 70 is part of a conferencing system, such as a telepresence system (from Cisco), WebEx system (from Cisco) or other online conference system. Any device for participating, hosting, and/or controlling online conferencing may be used.

Instructions embodying the activities or functions described herein may be stored on one or more external computer-readable media 79, in main memory 73, in the secondary storage 74, or in the cache memory of processor 72 of the network device 70. These memory elements of network device 70 are non-transitory computer-readable media. The logic for implementing the processes, methods and/or techniques discussed herein are provided on non-transitory computer-readable storage media or memories, such as a cache, buffer, RAM, removable media, hard drive or other computer readable storage media. Computer readable storage media include various types of volatile and nonvolatile storage media. Thus, ‘computer-readable medium’ is meant to include any medium that is capable of storing instructions for execution by network device 70 that cause the machine to perform any one or more of the activities disclosed herein.

The instructions stored on the memory as logic may be executed by the processor 72. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

The memory (e.g., external computer-readable media 79, in main memory 73, in the secondary storage 74, or in the cache memory of processor 72) also stores shared content, an identification of the current top speaker, a list of top speakers, an identification of a presenter, pointer location, foreground status, active status, and/or interaction information.

The wireless and wired network interfaces 75 and 76 may be provided to enable electronic communication between the network device 70 and other network devices via one or more networks. In one example, the wireless network interface 75 includes a wireless network interface controller (WNIC) with suitable transmitting and receiving components, such as transceivers, for wirelessly communicating within the network 10. In another example, the wireless network interface 75 is a cellular communications interface. The wired network interface 76 may enable the network device 70 to physically connect to the network 10 by a wire, such as an Ethernet cable. Both wireless and wired network interfaces 75 and 76 may be configured to facilitate communications using suitable communication protocols, such as the Internet Protocol Suite (TCP/IP).

The network device 70 is shown with both wireless and wired network interfaces 75 and 76 for illustrative purposes only. While one or both wireless and hardwire interfaces may be provided in the network device 70, or externally connected to network device 70, only one connection option is needed to enable connection of network device 70 to the network 10. The network device 70 may include any number of ports using any type of connection option.

The network interfaces 75 and/or 76 may be configured to transmit audio, video, information about user interaction or input, and/or shared content for online conferences. In one embodiment, the network interfaces 75 and/or 76 are configured to transmit shared content to participants, such as attendees, of an online conference. Updated shared content or content reflecting interaction by an attendee may be transmitted to the participants, including the presenter, or to just the presenter or other subset of participants. For example, the shared content with a pointer positioned by an attendee is transmitted to the attendees and the presenter.

Additionally or alternatively, the network interfaces 75 and/or 76 may be configured to receive audio, video, information about user interaction or input, and/or shared content for online conferences. In one embodiment, the network interfaces 75 and/or 76 are configured to receive position information from any attendee and/or a presenter. For example, position information about interaction of a top attendee with shared content is received. The position information indicates a position relative to the shared content of the video conference, such as a mouse cursor or touch cursor location. Other information, such as a type of interaction or function associated with the position, may be received.

The processor 72, which may also be a central processing unit (CPU), is any general or special-purpose processor capable of executing machine readable instructions and performing operations on data as instructed by the machine readable instructions. The main memory 73 or other memory may be accessible to processor 72 for accessing machine instructions and may be in the form of random access memory (RAM) or any type of dynamic storage (e.g., dynamic random access memory (DRAM)). The secondary storage 74 may be any non-volatile memory, such as a hard disk, which is capable of storing electronic data including executable software files. Externally stored electronic data may be provided to computer 70 through one or more removable media drives 78, which may be configured to receive any type of external media 79, such as compact discs (CDs), digital video discs (DVDs), flash drives, external hard drives, or any other external media.

The processor 72 is configured by the instructions and/or hardware to provide for attendee control of shared content or to assist in presentation of attendee interaction with shared content on a temporary basis. For example, the processor 72 is configured to determine the top attendee in a video conference. The video conference includes a presenter and one or more attendees. The processor 72 looks up from a table or calculates the attendee with the greatest audio energy or attendee satisfying any criteria as a primary speaker. The processor 72 may be configured for other checks to determine whether an attendee's interaction with shared content should be shared with the presenter or other participants.

If the attendee is the top speaker and/or other checks are satisfied, the processor 72 is configured to update the shared content. The interaction of the attendee with the shared content is received by the processor 72. The shared content is updated to reflect the interaction from the qualifying attendee. For example, the position information received from the top attendee is used to add a pointer at a location on the shared content. The processor 72 may limit the addition temporally, such as adding the pointer to the shared content for a limited time and then removing the pointer from the shared content. The processor 72 may prevent alteration or display of interaction with the shared content by other attendees and/or the presenter. The processor 72 may prevent interaction from any sub-set of the participants, such as only allowing interaction from the top attendee and the presenter at any given time.

A user interface 77 may be provided in none, some or all devices to allow a user to interact with the network device 70. The user interface 77 includes a display device (e.g., plasma display panel (PDP), a liquid crystal display (LCD), or a cathode ray tube (CRT)). In addition, any appropriate input device may also be included, such as a keyboard, a touch screen, a mouse, a trackball, microphone (e.g., input for audio), camera, buttons, and/or touch pad. In other embodiments, only the display (e.g., touch screen) is provided.

Additional hardware may be coupled to the processor 72 of the network device 70. For example, memory management units (MMU), additional symmetric multiprocessing (SMP) elements, physical memory, peripheral component interconnect (PCI) bus and corresponding bridges, or small computer system interface (SCSI)/integrated drive electronics (IDE) elements. The network device 70 may include any additional suitable hardware, software, components, modules, interfaces, or objects that facilitate operation. This may be inclusive of appropriate algorithms and communication protocols that allow for the effective protection and communication of data. Furthermore, any suitable operating system is configured in network device 70 to appropriately manage the operation of the hardware components therein.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. A method comprising:
presenting content from a screen of a presenter in an online conference on screens of a plurality of attendees;
identifying a primary speaker in the online conference, the primary speaker being a first one of the attendees and other than the presenter; and
showing, on screens of the presenter and the attendees, interaction of user input of the first attendee with the content only where the first attendee is the primary speaker.

2. The method of claim 1 wherein presenting the content comprises sharing a desktop or application of the presenter from a computer of the presenter.

3. The method of claim 1 wherein identifying the primary speaker comprises identifying the first attendee as speaking more loudly than any of the other attendees.

4. The method of claim 1 wherein identifying the primary speaker comprises identifying the primary speaker by accounting for background noise.

5. The method of claim 1 wherein showing comprises showing the interaction as a pointer on the content, the pointer labeled for the first attendee and moving based on the user input.

6. The method of claim 1 wherein showing comprises showing the first attendee zoom on, move, or select a portion of the content.

7. The method of claim 1 wherein showing comprises showing the interaction while the first attendee is silent.

8. The method of claim 1 wherein showing comprises showing the interaction for a limited time and then ceasing to show the interaction.

9. The method of claim 1 further comprising showing additional interaction of the presenter with the content while showing the interaction of the first attendee.

10. The method of claim 1 further comprising:
checking that the content is on a foreground and active on a screen of the first attendee;
wherein showing comprises showing the interaction only when the content is on the foreground and active.

11. The method of claim 1 further comprising:
checking that a cursor on a screen of the first attendee is within the content;
wherein showing comprises showing the interaction only when the cursor is within the content.

12. Logic encoded in one or more non-transitory computer-readable media that includes code for execution and when executed by a processor is operable to perform operations comprising:
displaying at least a part of a computer desktop from a presenter of an online conference on a screen;
receiving user input moving a cursor on the screen;
verifying that the part of the computer desktop from the presenter is on a foreground of the screen;
verifying that the cursor is within the part of the computer desktop from the presenter; and
transmitting, to a conferencing server, a position of the cursor or action associated with the cursor when both verifications are positive.

13. The logic of claim 12 wherein displaying comprises displaying of the at least the part of the computer desktop from the presenter in a window, and wherein verifying that the part is on the foreground comprises verifying that the window is active.

14. The logic of claim 12 wherein verifying that the cursor is within the part comprises verifying that the cursor moves within the part.

15. The logic of claim 12 wherein transmitting comprises transmitting the position and an indication of selection as the action.

16. The logic of claim 12 further comprising verifying that the processor is linked to a top attendee of the online conference;
wherein transmitting is performed only if the processor is verified to be linked to the top attendee.

17. An arrangement comprising:
an interface configured to receive position information from a top attendee, the position information being relative to shared content of an online conference; and
a processor configured to determine the top attendee in the online conference, the online conference including a presenter and multiple attendees, to update the shared content according to interaction using the position information from the top attendee, and to prevent alteration of the shared content by the attendees other than the top attendee;
wherein the interface is configured to transmit the shared content as updated.

18. The arrangement of claim 17 wherein the processor is configured to determine the top attendee as the attendee with a greatest audio energy.

19. The arrangement of claim 17 wherein the interface is configured to receive the position information as a cursor or touch location, wherein the processor is configured to update by adding a pointer at a location on the shared content, and wherein the interface is configured to transmit the shared content with the pointer to the attendees and the presenter.

20. The arrangement of claim 17 wherein the processor is configured to update by addition of a pointer to the shared content for a limited time and then removal of the pointer from the shared content.
